(19) United States
(12) Patent Application Publication
(10) Pub. No.: US 2007/0052891 A1
(43) Pub. Date: Mar. 8, 2007

(54) Display panel

(76) Inventors: Sang-Woo Kim, Suwon-si (KR); Won-Sang Park, Yongin-si (KR); Jae-Young Lee, Yongin-si (KR); Hae-Young Yun, Suwon-si (KR); Jae-Ik Lim, Chuncheon-si (KR); Young-Joo Chang, Suwon-si (KR); Seung-Kyu Lee, Yongin-si (KR); Chang-Woo Shim, Seoul (KR); Yong-Suk Yeo, Jecheon-si (KR); Sung-Eun Cha, Geoje-si (KR); Ji-Youn Choi, Suwon-si (KR); Hye-Jin Seo, Suwon-si (KR); Joo-Hee Oh, Suwon-si (KR)

Correspondence Address: CANTOR COLBURN, LLP, 55 GRIFFIN ROAD SOUTH, BLOOMFIELD, CT, 06002, US

(21) Appl. No.: 11/517,875

(22) Filed: Sep. 8, 2006

(30) Foreign Application Priority Data
Sep. 8, 2005 (KR) 10-2005-0083536
Sep. 13, 2005 (KR) 10-2005-0085068

(51) Int. Cl. G02F 1/1335

(52) U.S. Cl. 349/117

(57) ABSTRACT

A panel includes a first substrate, a second substrate facing the first substrate and first and second polarizers disposed on the outer surfaces of the first and the second substrates, respectively. The first and second polarizers include biaxial n-TAC as a supporter.

This application claims priority to Korean Patent Application Nos. 10-2005-0083536, filed on Sep. 8, 2005, and 10-2005-0085068, filed on Sep. 13, 2005, and all the benefits accruing therefrom under 35 U.S.C. §119, the contents of which in its entirety are herein incorporated by reference.

### BACKGROUND OF THE INVENTION

(a) Field of the Invention

The present invention relates to a thin film transistor array panel for a liquid crystal display.

(b) Description of the Related Art

A liquid crystal display (“LCD”) is one of the most widely used flat panel displays. An LCD includes two panels provided with field-generating electrodes such as pixel electrodes and a common electrode, and a liquid crystal (“LC”) layer interposed therebetween. The LCD displays images by applying voltages to the field-generating electrodes to generate an electric field in the LC layer, which determines orientations of LC molecules in the LC layer to adjust polarization of incident light.

The LCD also includes switching elements connected to the pixel electrodes, and a plurality of signal lines such as gate lines and data lines for transmitting the image signal to the pixel electrodes by controlling the switching element.

Among the LCDs, a vertical alignment (“VA”) mode LCD, which aligns LC molecules such that the long axes of the LC molecules are perpendicular to the panels in the absence of an electric field, is spotlighted because of its high contrast ratio and wide reference viewing angle. A wide reference viewing angle is defined as a viewing angle that makes the contrast ratio equal to 1:10 or as a limit angle for the inversion in luminance between the grays.

Also, a plurality of films are used to improve viewing angle and/or compensate phase differences in the VA mode LCD.

However, because the films are expensive, the production cost is increased. Also, when several films are used, the thickness of the LCD is thicker.

### BRIEF SUMMARY OF THE INVENTION

A motivation of the present invention is to provide a liquid crystal display having improved display characteristics by reducing the production cost and the thickness of the LCD, as well as to provide a wide viewing angle.

In an exemplary embodiment, a liquid crystal display is provided, which includes a first substrate, a second substrate facing the first substrate and first and second polarizers respectively disposed on the outer surfaces of the first and the second substrates, wherein the first and second polarizers include biaxial n-TAC as a supporter.

The transmittance axis of the first polarizer may be perpendicular to the transmittance axis of the second polarizer.

The Rth of the first and second polarizers may satisfy 100 nm≦Rth={(nx+ny)/2−nz}χd≦250 nm, where d is the thickness of the biaxial n-TAC of the first and second polarizers and the Rth is the retardation of the thickness direction in the biaxial n-TAC of the first and second polarizers.

The liquid crystal display may further include λ/4 phase difference plates respectively disposed between the first and second polarizers, and between the first and second substrates.

The R0 may satisfy 30 nm≦R0=(nx−ny)χd≦100 nm, where R0 is the retardation of a direction perpendicular to the Rth of the biaxial n-TAC of the first and second polarizers.

The λ/4 phase difference plates may have a fast axis, and the transmittance axes of the first and second polarizers and the fast axis of the λ/4 phase difference plates may make angles in the range of about 25 degrees to about 65 degrees, or about −25 degrees to about −65 degrees.

The transmittance axes of the first and second polarizers and the fast axis of the λ/4 phase difference plates may make angles of about ±45 degree.

The liquid crystal display may further include a liquid crystal layer formed between the first and second substrates, wherein the liquid crystal layer has a vertical alignment mode.

The liquid crystal display may further include alignment layers respectively formed on the inner surfaces of the first and second substrates.

The alignment layers may be rubbed.

The liquid crystal display may further include a plurality of pixel electrodes formed on the first substrate, and a common electrode formed on the second substrate.

The pixel electrodes may have a plurality of pixel electrode portions and at least one connection for electrically connecting the pixel electrode portions, and the common electrode may have a set of cutouts respectively disposed on the center of the pixel electrode portions.

The pixel electrode portions may have a rectangular shape with rounded corners.

In another exemplary embodiment, a liquid crystal display is provided, which includes a first substrate, a second substrate facing the first substrate, first and second polarizers respectively disposed on the outer surfaces of the first and second substrates, and a biaxial film disposed between the first substrate and the first polarizer.

The liquid crystal display may further include a uniaxial film disposed between the second substrate and the second polarizer.

The transmittance axes of the first and second polarizers may be perpendicular to each other.

The R0 and Rth of the biaxial film respectively satisfy 100 nm≦R0=(nx−ny)χd≦150 nm, and 200 nm≦Rth={(nx+ny)/2−nz}χd≦350 nm, where d is the thickness of the biaxial film, Rth is the retardation of the thickness direction in the biaxial film, and R0 is the retardation of a direction perpendicular to the Rth of the biaxial film.

The biaxial film may have a slow axis and fast axis, and a phase difference may be generated between light of the slow axis direction and light of the direction of the fast axis by λ/4 wavelength.

The transmittance axes of the first and second polarizers, and the fast axis or the slow axis of the biaxial film, may make angles in the range of about 25 degrees to about 65 degrees, or about −25 degrees to about −65 degrees.

The transmittance axes of the first and second polarizers, and the fast axis or slow axis of the biaxial film, may make angles of about ±45 degrees.

The liquid crystal display may further include a liquid crystal layer formed between the first and second substrates, wherein the liquid crystal layer has a vertical alignment mode.

The liquid crystal display may further include alignment layers respectively formed on the inner surfaces of the first and second substrates.

The alignment layers may be rubbed.

The liquid crystal display may further include a plurality of pixel electrodes formed on the first substrate, and a common electrode formed on the second substrate.

The pixel electrodes may have a plurality of pixel electrode portions and at least one connection for electrically connecting the pixel electrode portions, and the common electrode may have a set of cutouts respectively disposed on the center of the pixel electrode portions.

The pixel electrode portions may have a rectangular shape with rounded corners.

### BRIEF DESCRIPTION OF THE DRAWINGS

The present invention will become more apparent by describing exemplary embodiments thereof with reference to the accompanying drawings, in which:

FIG. 1 is a plan view layout of an LCD according to an exemplary embodiment of the present invention;

FIG. 2 is a cross-sectional view of the LCD shown in FIG. 1 taken along line II-II;

FIGS. 3, 5, 7 and 9 are plan view layouts of a TFT array panel shown in FIGS. 1 and 2 in intermediate steps of a manufacturing method thereof according to an exemplary embodiment of the present invention;

FIGS. 4, 6, 8 and 10 are cross-sectional views of the TFT array panel shown in FIGS. 3, 5, 7 and 9 taken along lines IV-IV, VI-VI, VIII-VIII and IX-IX, respectively;

FIGS. 11 to 13 are cross-sectional views of the common electrode panel shown in FIG. 1 in intermediate steps of a manufacturing method thereof according to an exemplary embodiment of the present invention;

FIG. 14 is a graph showing a contrast ratio depending on viewing angle of the LCD according to an exemplary embodiment of the present invention;

FIG. 15 is a cross-sectional view of an LCD according to another exemplary embodiment of the present invention; and

FIG. 16 is a graph showing a contrast ratio depending on viewing angle in the LCD according to another exemplary embodiment of the present invention.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the exemplary embodiments set forth herein.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

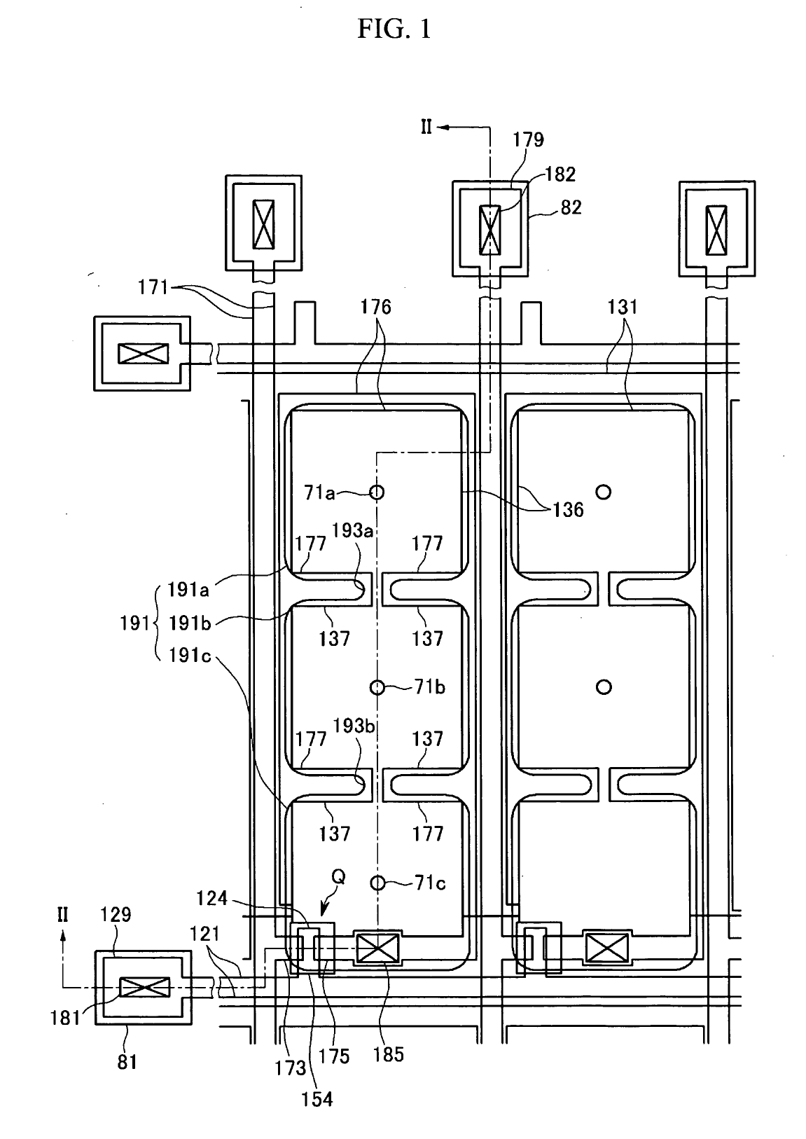

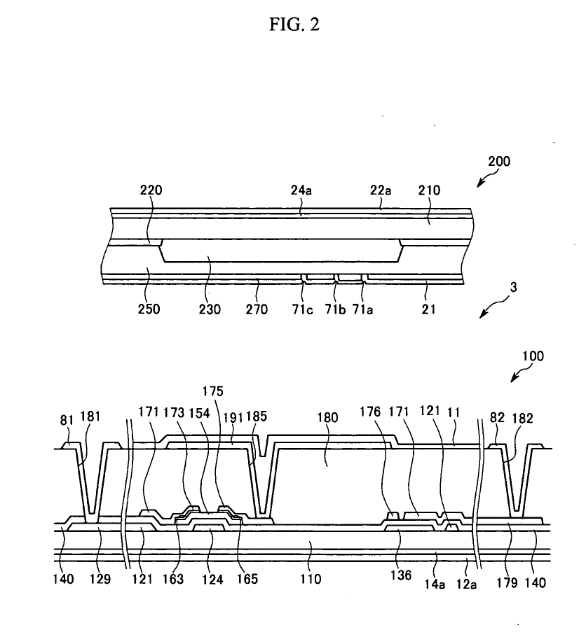

An LCD according to an exemplary embodiment of the present invention will be described with reference to FIGS. 1 and 2.

FIG. 1 is a plan view layout of an LCD according to an exemplary embodiment of the present invention, and FIG. 2 is a cross-sectional view of the LCD shown in FIG. 1 taken along line II-II.

An LCD according to an exemplary embodiment of the present invention includes a TFT array panel 100, a common electrode panel 200 and an LC layer 3 interposed between the panels 100 and 200.

The TFT array panel 100 is now described with reference to FIGS. 1 and 2.

A plurality of gate lines 121 and a plurality of storage electrode lines 131 are formed on an insulating substrate 110 made of a material such as transparent glass.

The gate lines 121 extend substantially in a transverse direction and are separated from each other, and the gate lines 121 transmit gate signals. Each gate line 121 includes a plurality of projections forming a plurality of gate electrodes 124 projecting upward, as illustrated in FIG. 1, and an end portion 129 having a large area for contact with another layer or an external driving circuit. A gate driving circuit (not shown) for generating the gate signals may be mounted on a flexible printed circuit (“FPC”) film (not shown), which may be attached to the substrate 110, directly mounted on the substrate 110, or integrated into the substrate 110. The gate lines 121 may extend to be connected to a driving circuit that may be integrated into the substrate 110.

Each of storage electrode lines 131, which are supplied with a predetermined voltage, extends substantially parallel to the gate lines 121 in the transverse direction and is disposed between two adjacent gate lines 121 and closer to an upper one of the two gate lines 121. Each storage electrode line 131 includes a plurality of vertical portions 136 extending in the vertical direction and a plurality of four transverse portions 137 extending in the right and left directions from the vertical portions 136, as illustrated in FIG. 1. However, the storage electrode lines 131 may have various shapes and arrangements.

The gate lines 121 and the storage electrode lines 131 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti, or Ta. The gate lines 121 and the storage electrode lines 131 may have a multi-layered structure including two films having different physical characteristics. One of the two films is preferably made of a low resistivity metal including an Al-containing metal, a Ag-containing metal, and a Cu-containing metal for reducing signal delay or voltage drop in the gate lines 121 and the storage electrode lines 131. The other film is preferably made of a material such as a Mo-containing metal, Cr, Ta, or Ti, which has good physical, chemical and electrical contact characteristics with other materials such as indium tin oxide (ITO) or indium zinc oxide (IZO). Examples of the combination of the two films include a lower Cr film and an upper Al alloy film, and a lower Al film and an upper Mo film. However, the gate lines 121 and the storage electrode lines 131 may be made of various metals or conductors.

In addition, the lateral sides of the gate lines 121 and the storage electrode lines 131 are inclined relative to a surface of the substrate. The inclination angle thereof ranges about 30 degrees to about 80 degrees.

A gate insulating layer 140 preferably made of silicon nitride (SiNx) is formed on the gate lines 121 and the storage electrode lines 131.

A plurality of semiconductor islands 154 preferably made of hydrogenated amorphous silicon (abbreviated to “a-Si”) or polysilicon are formed on the gate insulating layer 140. Each semiconductor island 154 is disposed on a respective gate electrode 124.

A plurality of ohmic contact islands 163 and 165 preferably made of silicide or n+ hydrogenated a-Si heavily doped with an n-type impurity such as phosphorous are formed on the semiconductor islands 154. The ohmic contact islands 163 and 165 are located in pairs on the semiconductor islands 154.

The lateral sides of the semiconductor islands 154 and the ohmic contacts 163 and 165 are inclined relative to a surface of the substrate. The inclination angles thereof are preferably in a range between about 30 degrees to about 80 degrees.

A plurality of data lines 171 and a plurality of drain electrodes 175 separated from the data lines 171 are formed on the ohmic contacts 163 and 165 and on the gate insulating layer 140.

The data lines 171 for transmitting data voltages extend substantially in the longitudinal direction and cross the gate lines 121 and the storage electrode lines 131. Each data line 171 includes a plurality of source electrodes 173 projecting toward the gate electrodes 124 and an end portion 179 having a large area for contact with another layer or an external device, as best illustrated in FIG. 1. A data driving circuit (not shown) for generating the data signals may be mounted on an FPC film (not shown). The FPC film may be attached to the substrate 110, directly mounted on the substrate 110, or integrated into the substrate 110. The data lines 171 may extend to be connected to a driving circuit that may be integrated into the substrate 110.

Each drain electrode 175 is separated from the data lines 171 and faces a respective source electrode 173 with respect to the corresponding gate electrode 124.

The drain electrodes 175 include a plurality of storage capacitor conductors 176 overlapping the vertical portions 136 of the storage electrode lines 131, which are disposed in the right and left sides of the pixels and the storage electrode lines 131 parallel to the gate lines 121. Also, the storage capacitor conductors 176 include four projections 177 in the right and left sides projecting from the storage capacitor conductors 176 and overlapping the transverse portions 137 of the storage electrode lines 137.

A gate electrode 124, a source electrode 173 and a drain electrode 175 along with the semiconductor island 154 form a TFT having a channel formed in the semiconductor island 154 disposed between the source electrode 173 and the drain electrode 175.

The data lines 171 and the drain electrodes 175 are preferably made of a refractory metal such as Cr, Mo, Ti, Ta, or alloys thereof. However, they may also have a multilayered structure including a low-resistivity film (not shown) and a good-contact film (not shown). An example of the combination includes a lower Mo (alloy) film, an intermediate Al (alloy) film, and an upper Mo (alloy) film as well as the above-described combinations of a lower Cr film and an upper Al (alloy) film and a lower Al (alloy) film and an upper Mo (alloy) film. However, the data lines 171, the drain electrodes 175 and the storage capacitor conductors 176 may be made of various metals or conductors.

Like the gate lines 121, the data lines 171 and the drain electrodes 175 have tapered lateral sides. The inclination angles thereof range about 30 degrees to about 80 degrees.

The ohmic contacts 163 and 165 are interposed only between the underlying semiconductor islands 154 and the overlying data lines 171 and the overlying drain electrodes 175 thereon, and reduce the contact resistance therebetween. The semiconductor islands 154 include a plurality of exposed portions, which are not covered with the data lines 171 and the drain electrodes 175, such as portions located between the source electrodes 173 and the drain electrodes 175.

A passivation layer 180 is formed on the data lines 171, the drain electrodes 175 and the exposed portions of the semiconductors 154. The passivation layer 180 is preferably made of an inorganic or organic insulator and it may have a flat top surface. Examples of the inorganic insulator material include silicon nitride and silicon oxide. The organic insulator may have photosensitivity and a dielectric constant of less than about 4.0. The passivation layer 180 may include a lower film of an inorganic insulator and an upper film of an organic insulator such that it uses the excellent insulating characteristics of the organic insulator while preventing the exposed portions of the semiconductors 154 from being damaged by the organic insulator.

The passivation layer 180 has a plurality of contact holes 182 and 185 exposing the end portions 179 of the data lines 171, and the end portions of the drain electrodes 175, respectively. The passivation layer 180 and the gate insulating layer 140 have a plurality of contact holes 181 exposing the end portions 129 of the gate lines 121.

A plurality of pixel electrodes 191 and a plurality of contact assistants 81 and 82, which are preferably made of a transparent conductor such as ITO or IZO or a reflective conductor such as Ag or Al, are formed on the passivation layer 180.

The pixel electrodes 191 include first to third pixel electrode portions 191a, 191b and 191c, and first and second connections 193a and 193b to connect the first to third pixel electrode portions 191a-191c. The first to third pixel electrode portions 191a-191c are arranged in a line and each has a rectangular shape with four rounded corners. The first connection 193a is disposed between the first pixel electrode portion 191a and the second pixel electrode portion 191b, and is electrically connected to the first pixel electrode portion 191a and the second pixel electrode portion 191b. The second connection 193b is disposed between the second pixel electrode portion 191b and the third pixel electrode portion 191c, and is electrically connected to the second pixel electrode portion 191b and the third pixel electrode portion 191c.

The third pixel electrode portions 191a-191c may have a polygonal shape or a round shape.

The third pixel electrode portion 191c is physically and electrically connected to the drain electrodes 175 through the contact hole 185 such that the pixel electrodes 191 receive the data voltages from the drain electrodes 175.

The pixel electrodes 191 supplied with the data voltages generate electric fields in cooperation with the common electrode 270. The electric fields determine the orientations of liquid crystal molecules in the liquid crystal layer 3.

A pixel electrode 191 and the common electrode 270 of the common electrode panel 200 form a liquid crystal capacitor, which stores applied voltages after turn-off of the TFT.

An additional capacitor called a “storage capacitor,” which is connected in parallel to the liquid crystal capacitor, is provided for enhancing the voltage storing capacity of the liquid crystal capacitor. The storage capacitors are implemented by overlapping the storage capacitor conductors 176 connected to the drain electrode 175 and the pixel electrode 191 with the vertical and transverse portions 136 and 137 of the storage electrode lines 131 as well as the storage electrode lines 131.

The transverse portions 137 of the storage electrode lines 131 and the projections 177 of the drain electrode 175 block the leakage light passing between the first pixel electrode portion 191a and the second pixel electrode portion 191b, and the second pixel electrode portion 191b and the third pixel electrode portion 191c.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and complement the adhesion of the end portions 129 and 179 and external devices.

A description of the common electrode panel 200 follows with reference to FIGS. 1 and 2.

A light blocking member 220 called a black matrix for preventing light leakage between the pixel electrodes 191 is formed on an insulating substrate 210 made of a material such as transparent glass. The light blocking member 220 includes a plurality of openings that face the pixel electrodes 191, and has substantially the same planar shape as the pixel electrodes 191.

A plurality of color filters 230 are formed on the substrate 210, and they are disposed substantially in the areas enclosed by the light blocking member 220. The color filters 230 (only one shown) may extend substantially along the longitudinal direction along the pixel electrodes 191. The color filters 230 may represent one of the primary colors such as red, green and blue colors.

An overcoat 250 for preventing the color filters 230 from being exposed and for providing a flat surface is formed on the color filters 230 and the light blocking member 220. However, the overcoat 250 may be omitted in alternative exemplary embodiments.

A common electrode 270 preferably made of a transparent conductive material such as ITO and IZO is formed on the overcoat 250.

The common electrode 270 has a plurality of sets of cutouts 71a, 71b and 71c to determine the alignment direction of the liquid molecules.

The cutouts 71a-71c respectively face the centers of the first to third pixel electrode portions 191a-191c.

Upon application of the common voltage to the common electrode 270 and a data voltage to the pixel electrodes 191, a distortion of the electric field is generated in the regions adjacent to the cutouts 71a-71c and the edges of the first to third pixel electrode portions 191a to 191c. The LC molecules tend to diversely change their orientations in response to the distorted electric field, thereby increasing the viewing angle of the LCD. Also, the response time of the LC molecules may be improved.

At least one of the cutouts 71a-71c can be substituted with protrusions or depressions, and the shapes and the arrangements of the cutouts 71a-71c may be modified. The protrusions may be made of an organic material or an inorganic material and may be disposed on or under the field-generating electrodes 191 and 270.

Alignment layers 11 and 21 are coated on inner surfaces of the panels 100 and 200, respectively, and λ/4 phase difference plates 14a and 24a and biaxial n-TAC polarizers 12a and 22a including biaxial n-TAC as a supporter are provided on outer surfaces of the panels 100 and 200, respectively.

The polarization axes of the biaxial n-TAC polarizers 12a and 22a are crossed, and the refractive indexes nx, ny and nz of the directions of the x, y and z axes are different in the biaxial n-TAC polarizers 12a and 22a.

The upper and lower λ/4 phase difference plates 14a and 24a have a fast axis and a slow axis which are crossed, and they change circular polarization light into linear polarization light or change linear polarization light into circular polarization light by generating a phase difference by λ/4 wavelength with respect to the polarization gradient parallel to the fast axis and the polarization gradient perpendicular thereto. It is preferable that the transmittance axes of the polarizers 12a and 22a and the fast axis or slow axis of the λ/4 phase difference plates 14a and 24a are at 45 degrees to generate a maximum phase difference. If the transmittance axes of the polarizers 12a and 22a and the fast axis or slow axis of the λ/4 phase difference plates 14a and 24a are not parallel and are perpendicular to each other, they may make various angles, and it is preferable that the transmittance axes of the polarizers 12a and 22a and the fast axis or slow axis of the λ/4 phase difference plates 14a and 24a make the angles in the range of about 25 degrees to about 65 degrees, or about −20 degrees to about −65 degrees.

The circular polarization light is used in the exemplary embodiment of the present invention, and accordingly the response time of the LC may be improved and the texture that is formed with a radial shape on the cutouts 71a-71c may be removed.

The λ/4 phase difference plates 14a and 24a and the biaxial n-TAC polarizers 12a and 22a have the below-described characteristics:
30 nm≦R0=(nx−ny)χd≦100 nm; and
100 nm≦Rth={(nx+ny)/2−nz}χd≦250 nm,
where d is the thickness of the biaxial n-TAC polarizers 12a and 22a, Rth is the retardation of the thickness direction in the biaxial n-TAC polarizers 12a and 22a, and R0 is the retardation of the direction perpendicular to the Rth of the biaxial n-TAC polarizers 12a and 22a in the λ/4 phase difference plates 14a and 24a.

The λ/4 phase difference plates 14a and 24a may be omitted in alternative exemplary embodiments.

As above-described, because the extra compensation films may be omitted, the thickness and the production cost of the LCD may be reduced, and the limitation of the range of Rth of the biaxial n-TAC polarizers 12a and 22a may be reduced as well.

The alignment of the LC molecules of the LC layer 3 may be vertical alignment (“VA”), twisted nematic (“TN”), mixed twisted nematic (“MTN”), homogenous alignment, and reverse electrically controlled birefringence (“Reverse ECB”). It is preferable that the LC layer 3 has negative dielectric anisotropy and is subjected to a vertical alignment such that the LC molecules in the LC layer 3 are aligned with their long axes substantially vertical to the surfaces of the panels 100 and 200 in the absence of an electric field.

The LCD may further include a plurality of spacers (not shown) for forming a cell gap between the panels 100 and 200 by supporting the panels 100 and 200.

Also, the LCD may further include a sealant (not shown) for combining the panels 100 and 200 The sealant may be disposed on the edge of the common electrode panel 200.

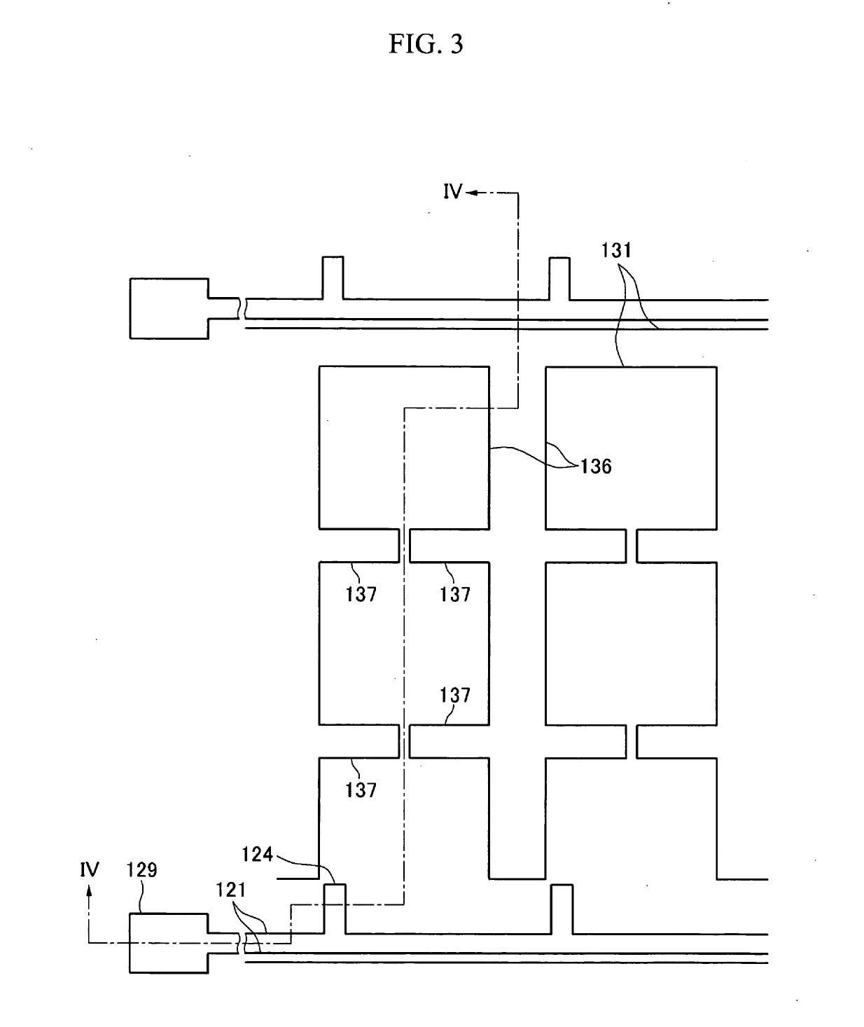

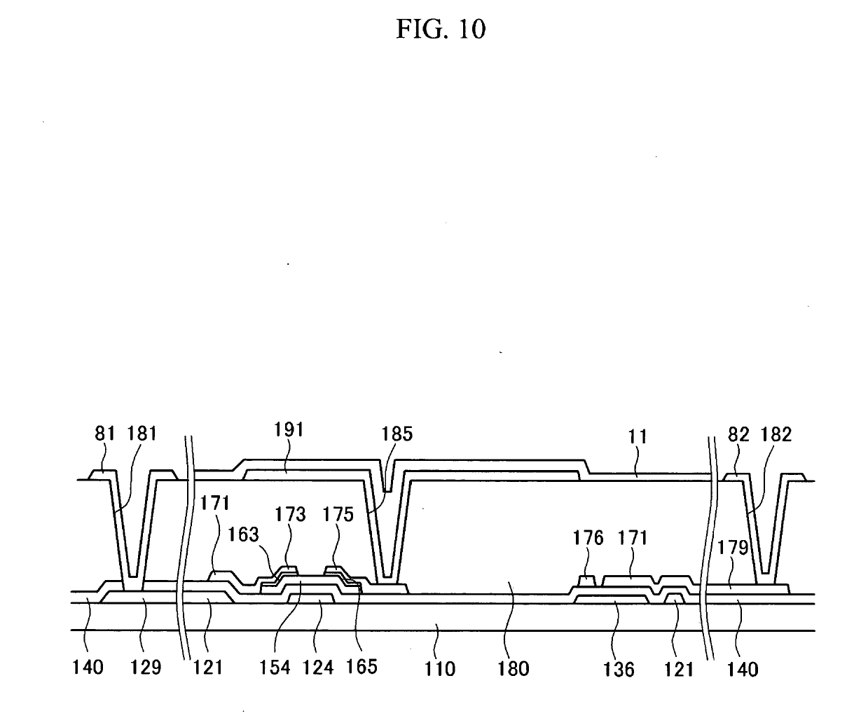

A method of manufacturing the TFT array panel for the LCD shown in FIGS. 1 and 2 according to an exemplary embodiment of the present invention will be now described with reference to FIGS. 3 to 12 as well as FIGS. 1 and 2.

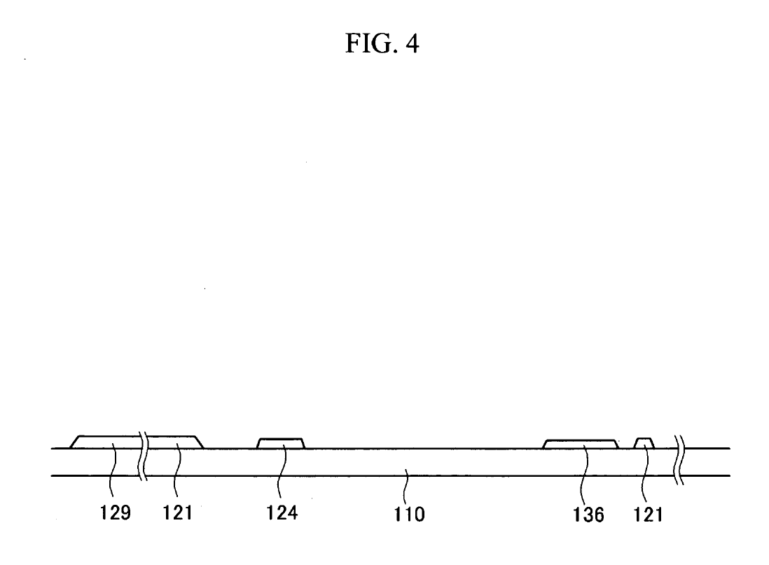

As shown in FIGS. 3 and 4, a conductive film is sputtered and patterned by photo-etching with a photoresist pattern to form a plurality of gate lines 121 including a plurality of gate electrodes 124 and a plurality of end portions 129, and a plurality of storage electrode lines 131.

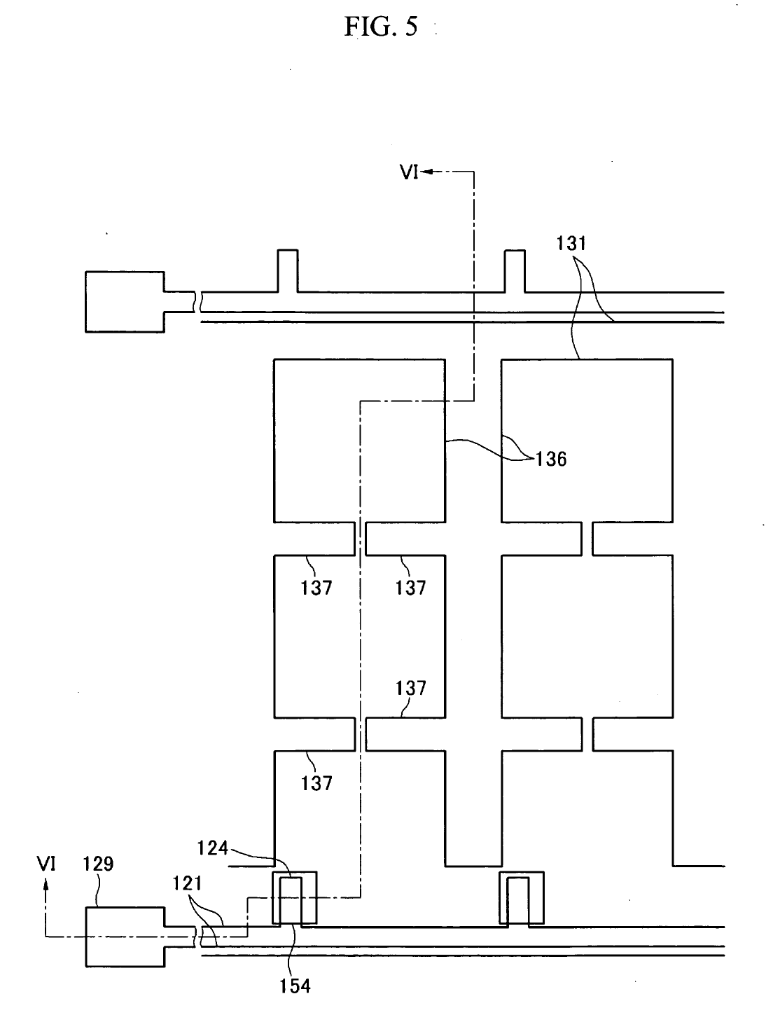

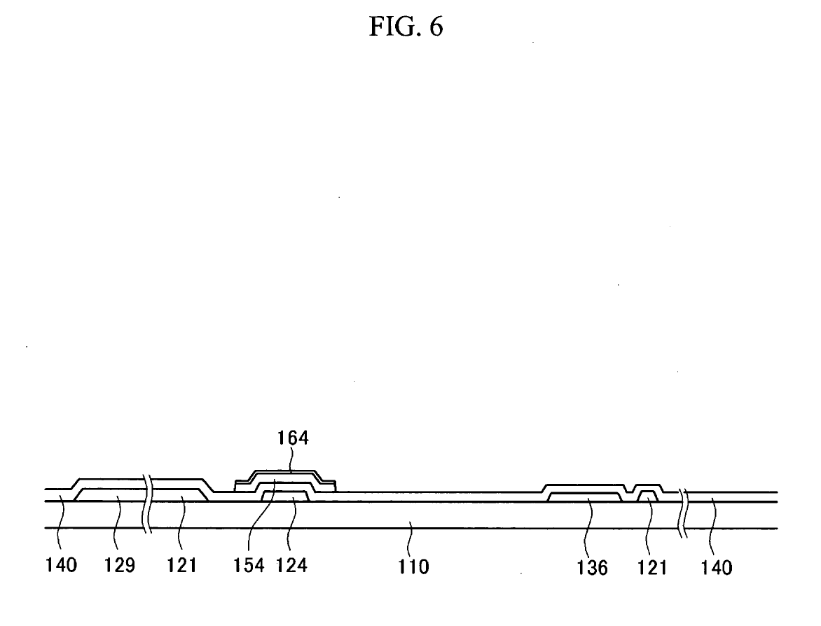

Referring to FIGS. 5 and 6, after sequential deposition of a gate insulating layer 140, an intrinsic a-Si layer, and an extrinsic a-Si layer, the extrinsic a-Si layer and the intrinsic a-Si layer are photo-etched to form a plurality of extrinsic semiconductor stripes 164 and a plurality of intrinsic semiconductors 154 on the gate insulating layer 140. The gate insulating layer 140 is preferably made of silicon nitride.

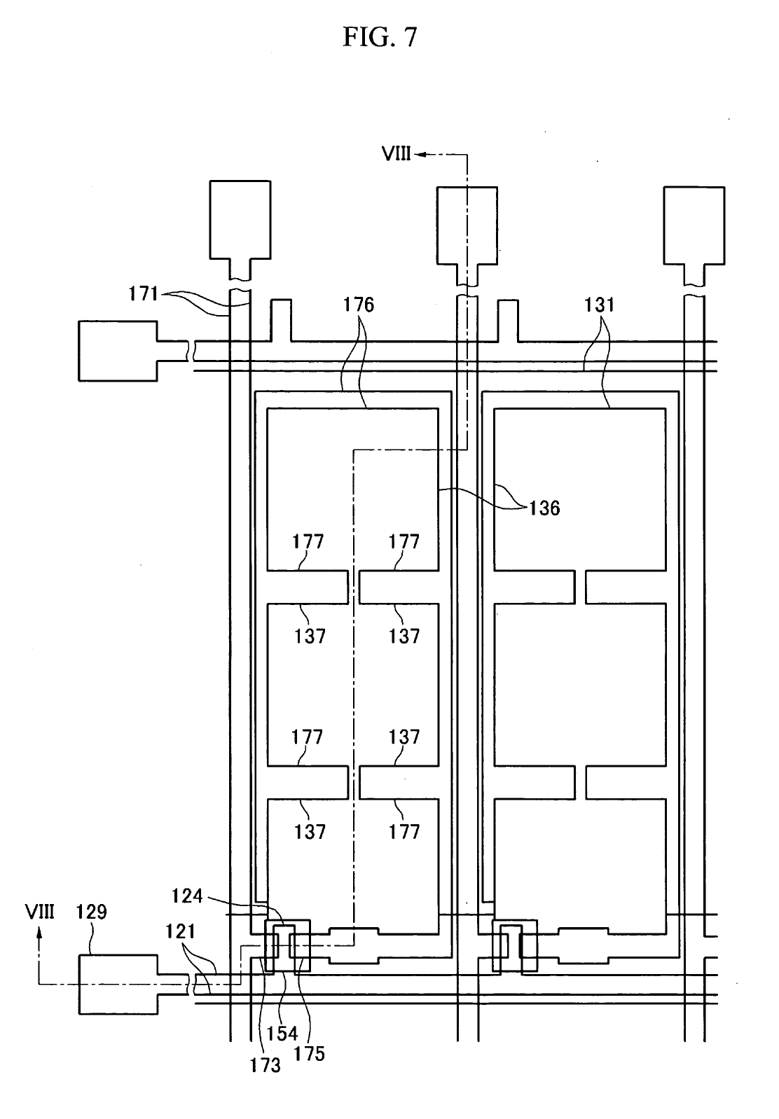

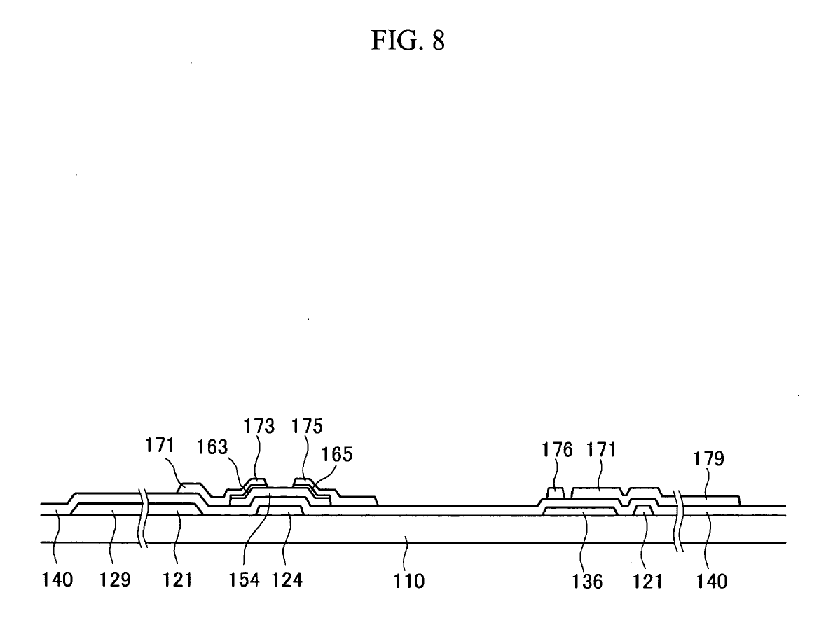

Referring to FIGS. 7 and 8, a conductive layer is sputtered and etched using a photoresist film (not shown) to form a plurality of data lines 171 including a plurality of source electrodes 173, a plurality of drain electrodes 175, and a plurality of storage capacitor conductors 176.

Before or after removing the photoresist film, portions of the extrinsic semiconductor stripes 164, which are not covered with the data lines 171, the drain electrodes 175, and the storage capacitor conductors 176, are removed by etching to complete a plurality of ohmic contacts 163 and 165 and to expose portions of the intrinsic semiconductors 154. Oxygen plasma treatment may follow thereafter in order to stabilize the exposed surfaces of the semiconductors 154.

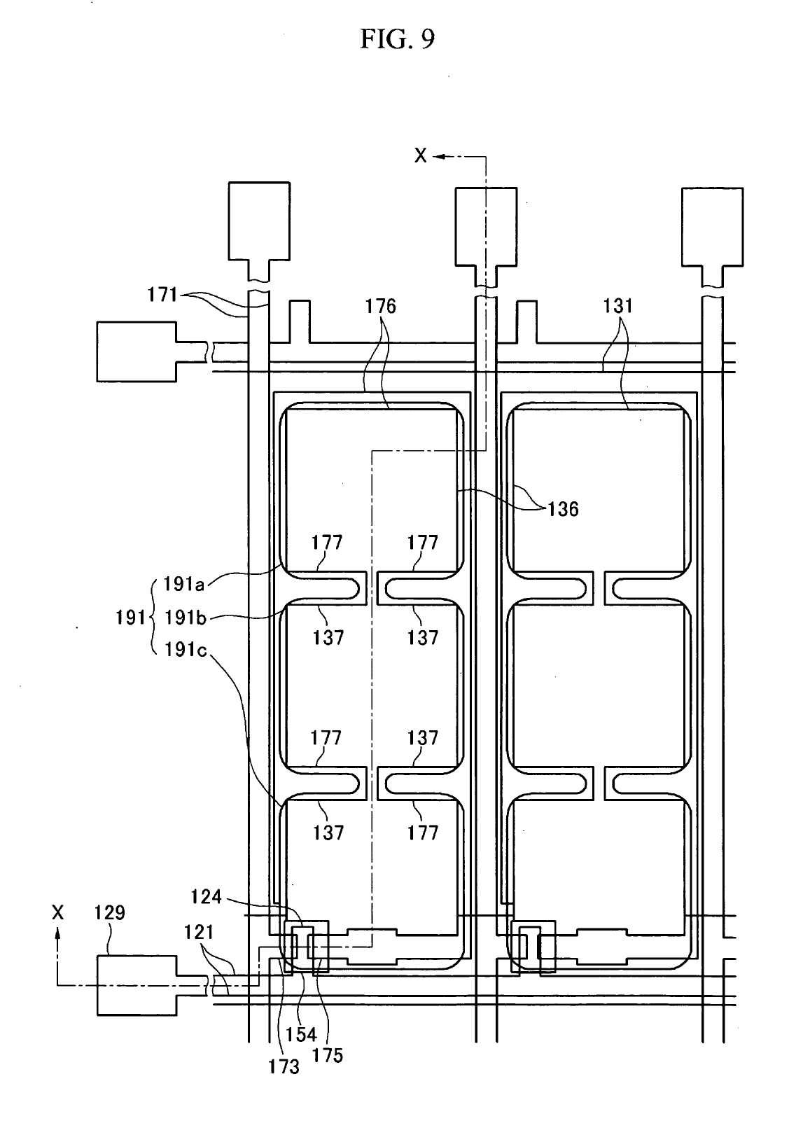

Referring to FIG. 9, a passivation layer 180 is formed and etched along with the gate insulating layer 140 to complete a plurality of contact holes 181, 182 and 185 exposing the end portions 129 of the gate lines 121, the end portions 179 of the data lines 171 and the drain electrodes 175, respectively.

Next, a conductive layer preferably made of a transparent material such as ITO and IZO is deposited by sputtering, and is etched using the photoresist as an etch mask to form a plurality of pixel electrodes 190 and a plurality of contact assistants 81 and 82. Then, an alignment layer 11 is coated on the pixel electrodes 191. The alignment layer 11 may be rubbed.

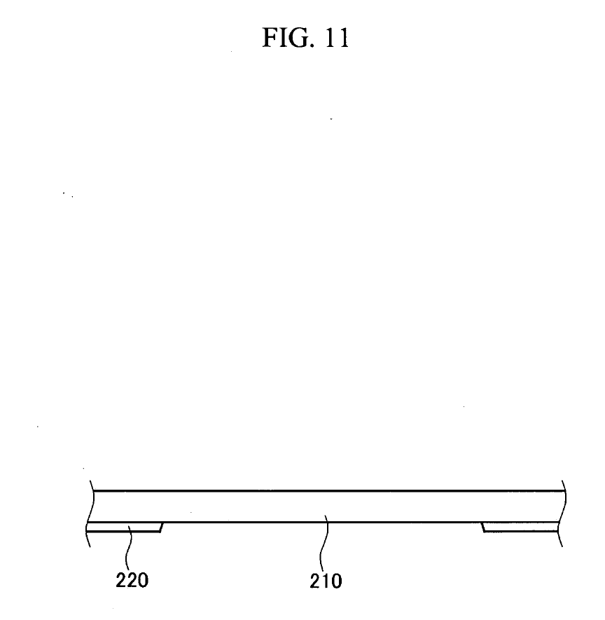

A method of manufacturing the common electrode panel for the LCD shown in FIGS. 1 and 2 according to an exemplary embodiment of the present invention will now be described with reference to FIGS. 11 to 13 as well as FIGS. 1 and 2.

As shown in FIG. 11, a light blocking member 220 is formed on an upper insulating substrate 210 made of a material such as transparent glass. It is preferable that a metal layer such as Cr, or double layers including the metal layer and a metal oxide layer, is deposited and patterned by using photolithography to form the light blocking member 220.

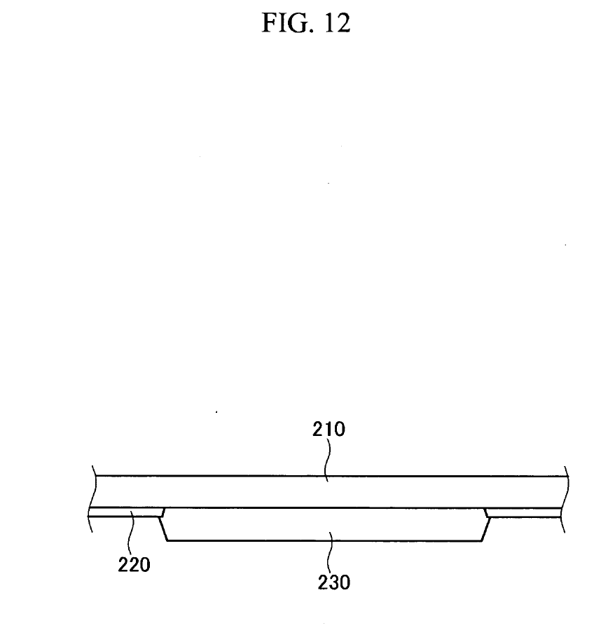

Next, as shown in FIG. 12, a plurality of color filters 230 (only one shown) are formed in the openings of the light blocking member 220. The color filters 230 generally represent one of the primary colors such as red, green, and blue colors. In exemplary embodiments, the thickness of the color filters 230 is thicker than a thickness of the light blocking member 220. A photosensitive pigment dispersion resin having color spectrum characteristics is coated on the upper insulating substrate 210 and is baked on a hot plate. Then, the resin layer is photo-etched to form the color filters 230 of red, green and blue.

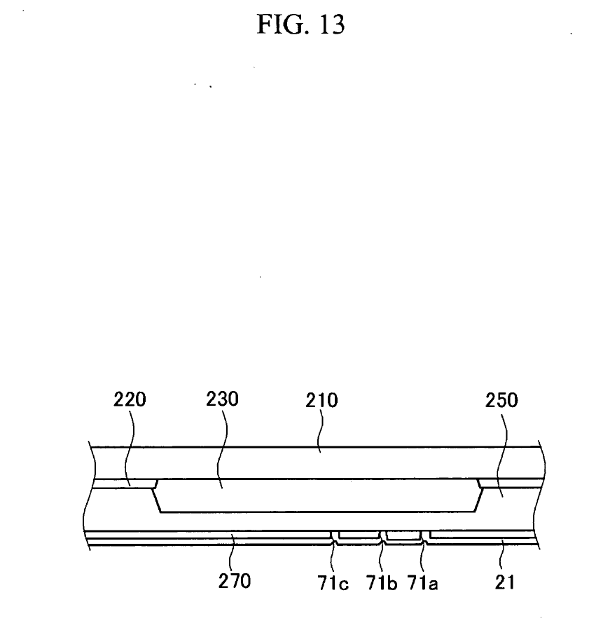

Next, as shown in FIG. 13, an overcoat 250 is formed on the color filters 230 and the light blocking member 220. A common electrode 270 preferably made of a transparent conductive material such as ITO is formed on the overcoat 250. Then, an alignment layer 22 is coated on the common electrode 270. The alignment layer 22 may be rubbed.

Then, after aligning and combining the thin film transistor array panel 100 and the common electrode 270, a lower λ/4 phase difference plate 14a and a lower biaxial n-TAC polarizer 12a are attached on the outer surface of the lower insulating substrate 110, and an upper λ/4 phase difference plate 24a and a lower biaxial n-TAC polarizer 22a are attached on the outer surface of the upper insulating substrate 210. Here, the transmittance axis of the lower biaxial n-TAC polarizer 12a is generally perpendicular to that of the upper biaxial n-TAC polarizer 22a, and the transmittance axes of the biaxial n-TAC polarizers 12a and 22a may be parallel to each other depending on the mode of the LCD.

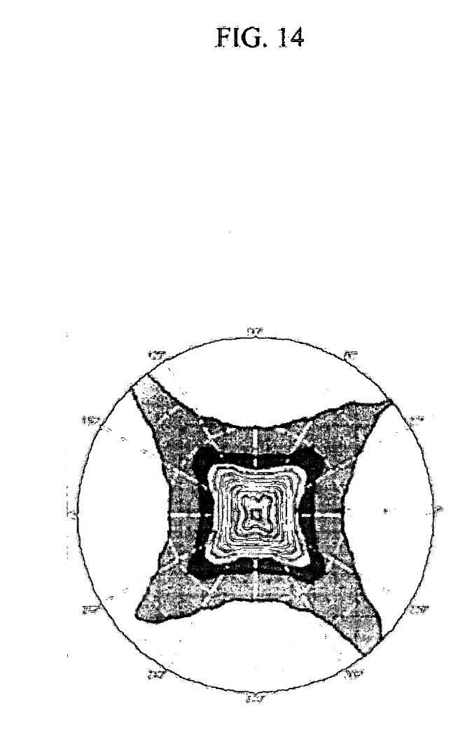

FIG. 14 is a graph showing a contrast ratio depending on viewing angle in the LCD according to an exemplary embodiment of the present invention.

As shown in FIG. 14, an improved viewing angle and good visibility can gained by using the λ/4 phase difference plates 14a and 24a.

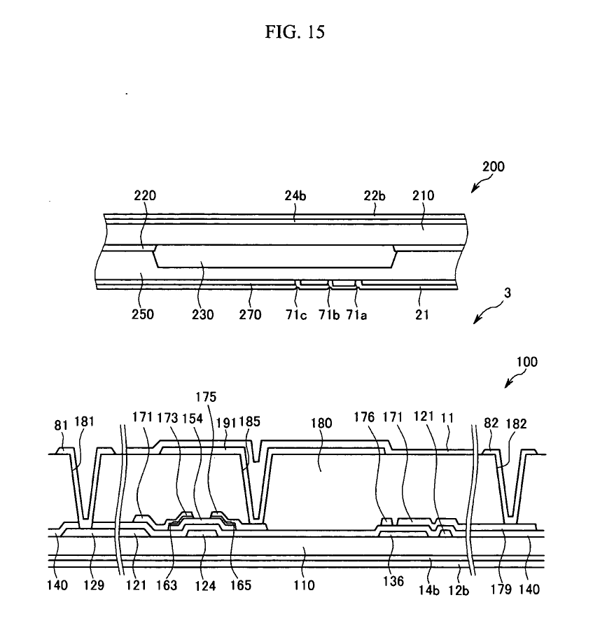

FIG. 15 is a cross-sectional view of an LCD according to another exemplary embodiment of the present invention.

Referring to FIG. 15, an LCD according to this exemplary embodiment also includes a TFT array panel 100, a common electrode panel 200 and an LC layer 3 interposed between the panels 100 and 200.

Layered structures of the panels 100 and 200 according to this exemplary embodiment are substantially the same as those shown in FIG. 2.

Regarding the TFT array panel 100, a plurality of gate lines 121 including gate electrodes 124 and end portions 129 and a plurality of storage electrode lines 131 including transverse and vertical portions 137 and 136, respectively, are formed on a substrate 110. A gate insulating layer 140, a plurality of semiconductors 154, and a plurality of ohmic contacts 163 and 165 are sequentially formed on the gate lines 121 and the storage electrodes lines 131. A plurality of data lines 171 including source electrodes 173 and end portions 179 and a plurality of drain electrodes 175 including storage capacitor conductors 176 are formed on the ohmic contacts 163 and 165. A passivation layer 180 is formed on the data lines 171, the drain electrodes 175, and exposed portions of the semiconductors 154. A plurality of contact holes 181, 182 and 185 are provided at the passivation layer 180 and the gate insulating layer 140, and a plurality of pixel electrodes 191 and a plurality of contact assistants 81 and 82 are formed on the passivation layer 180 and an alignment layer 11 is coated thereon.

Regarding the common electrode panel 200, a light blocking member 220, a plurality of color filters 230, an overcoat 250, a common electrode 270 having cutouts 71-71c, and an alignment layer 21 are formed on an insulating substrate 210.

Different from the LCD shown in FIG. 2, a biaxial film 14b and a uniaxial film 24b and polarizers 12b and 22b including a general tetra acetate (“TAC”) film as a supporter are provided on the respective outer surfaces of the panels 100 and 200.

The upper and lower polarizers 12b and 22b respectively have polarization axes that are crossed.

The refractive indexes nx, ny and nz of the directions of the x, y and z axes are different in the biaxial film 14b. The refractive indexes nx, ny and nz of one of the directions of the x, y and z axes are only different in the uniaxial film 24b.

The biaxial film 14b has a fast axis and a slow axis that are crossed, and the fast axis of the biaxial film 14b provides a faster phase to light than the slow axis. It is preferable that the biaxial film 14b generates a phase difference by λ/4 wavelength between light of the fast axis and light of the slow axis. It is preferable that the transmittance axes of the polarizers 12b and 22b and the fast axis or slow axis of the biaxial film 14b are 45 degrees to generate the maximum phase difference. If the transmittance axes of the polarizers 12b and 22b and the fast axis or slow axis of the biaxial film 14b are not parallel or perpendicular to each other, they may make various angles, and it is preferable that the transmittance axes of the polarizers 12b and 22b and the fast axis or slow axis of the biaxial film 14b make angles in the range of about 25 degrees to about 65 degrees, or about −25 degrees to about −65 degrees. By generating the phase difference by λ/4 wavelength, the linear polarization light can be changed to circular polarization light.

The circular polarization light is used in the exemplary embodiment of the present invention, and accordingly the response time of the LC may be improved and the texture that is formed with a radial shape on the cutouts 71a-71c may be removed.

The biaxial film 14b has the below-described characteristics:
100 (nm)≦R0=(nx−ny)χd≦150(nm); and
200 (nm)≦Rth={(nx+ny)/2−nz}χd≦350 (nm),
   where d is the thickness of the biaxial film 14b, Rth is the retardation of the thickness direction in the biaxial film 14b, and R0 is the retardation of the direction perpendicular to the Rth of the biaxial film 14b. When considering Rth of the uniaxial film 24b and the upper and lower polarizers 12b and 22b, Rth of the biaxial film 14b may be increased.

The biaxial film 14b may be attached on the outer surface of the substrate 210 of the common electrode panel 200, and the uniaxial film 24b may be attached on the outer surface of the substrate 110 of the thin film transistor array panel 100. However, the uniaxial film 24b may be omitted in alternative exemplary embodiments.

As above-described, because the extra compensation films may be omitted and one film and one biaxial film 14b may be used, the thickness and the production cost of the LCD may be reduced and the viewing angle may be improved without the limitation of the range of Rth. Also, the viewing angle may be further improved by increasing the Rth of the biaxial film 14b.

When the Rth of the biaxial film 14b is not large enough, the Rth of the tetra acetate (“TAC”) film of the polarizers 12b and 22b as a supporter may be increased to supplement the Rth.

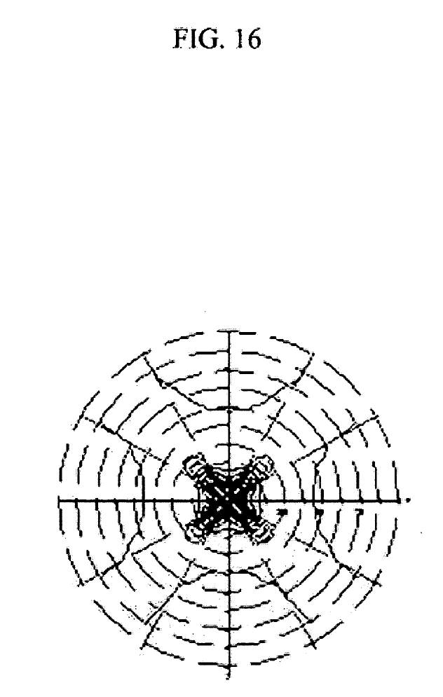

FIG. 16 is a graph showing a contrast ratio depending on viewing angle in the LCD according to another exemplary embodiment of the present invention.

As shown in FIG. 16, an improved viewing angle may be gained by increasing the Rth and using the biaxial film 14b.

As described above, the λ/4 phase difference plates and the biaxial n-TAC polarizers are attached on the outer surfaces of the substrates, or the biaxial film and the uniaxial film are respectively attached on the outer surfaces of the substrates. Accordingly, the thickness and the production cost of the LCD may be reduced, and the limitation of the range of Rth may also be reduced. Also, the viewing angle may be improved.

While the present invention has been described with reference to the exemplary embodiments, those skilled in the art will appreciate that various modifications and substitutions can be made thereto without departing from the spirit and scope of the present invention as set forth in the appended claims.

What is claimed is:

1. A liquid crystal display, comprising:
a first substrate;
a second substrate facing the first substrate; and
first and second polarizers respectively disposed on the outer surfaces of the first and second substrates;
wherein the first and second polarizers include biaxial n-TAC as a supporter.

2. The liquid crystal display of claim 1, wherein the transmittance axis of the first polarizer is perpendicular to the transmittance axis of the second polarizer.

3. The liquid crystal display of claim 1, wherein Rth of the first and second polarizers satisfies 100 nm≦Rth={(nx+ny)/2−nz}χd≦250 nm, where d is the thickness of the biaxial n-TAC of the first and second polarizers and the Rth is the retardation of the thickness direction in the biaxial n-TAC of the first and second polarizers.

4. The liquid crystal display of claim 1, further comprising:
λ/4 phase difference plates respectively disposed between the first and second polarizers, and the first and second substrates.

5. The liquid crystal display of claim 4, wherein R0 satisfies 30 nm≦R0=(nx−ny)χd≦100 nm, where d is the thickness of the biaxial n-TAC of the first and second polarizers and R0 is the retardation of a direction perpendicular to the Rth of the biaxial n-TAC of the first and second polarizers.

6. The liquid crystal display of claim 4, wherein the λ/4 phase difference plates have a fast axis, and the transmittance axes of the first and second polarizers, and the fast axis of the λ/4 phase difference plates makes angles in the range of about 25 degrees to about 65 degrees, or about −25 degrees to about −65 degrees.

7. The liquid crystal display of claim 6, wherein the transmittance axes of the first and second polarizers, and the fast axis of the λ/4 phase difference plates make angles of about ±45 degrees.

8. The liquid crystal display of claim 1, further comprising:
a liquid crystal layer formed between the first and second substrates,
wherein the liquid crystal layer has a vertical alignment mode.

9. The liquid crystal display of claim 1, further comprising:
alignment layers respectively formed on the inner surfaces of the first and second substrates.

10. The liquid crystal display of claim 9, wherein the alignment layers are rubbed.

11. The liquid crystal display of claim 1, further comprising:
a plurality of pixel electrodes formed on the first substrate; and
a common electrode formed on the second substrate.

12. The liquid crystal display of claim 11, wherein the pixel electrodes have a plurality of pixel electrode portions and at least one connection for electrically connecting the pixel electrode portions, and the common electrode has a set of cutouts respectively disposed on the center of the pixel electrode portions.

13. The liquid crystal display of claim 12, wherein the pixel electrode portions have a rectangular shape with rounded corners.

14. A liquid crystal display, comprising:
a first substrate;
a second substrate facing the first substrate;
first and second polarizers respectively disposed on the outer surfaces of the first and second substrates; and
a biaxial film disposed between the first substrate and the first polarizer.

15. The liquid crystal display of claim 14, further comprising:
a uniaxial film disposed between the second substrate and the second polarizer.

16. The liquid crystal display of claim 14, wherein the transmittance axes of the first and second polarizers are perpendicular to each other.

17. The liquid crystal display of claim 14, wherein R0 and Rth of the biaxial film respectively satisfy 100 nm≦R0=(nx−ny)χd≦150 nm, and 200 nm≦Rth={(nx+ny)/2−nz}χd≦350 nm, where d is the thickness of the biaxial film, Rth is the retardation of the thickness direction in the biaxial film, and R0 is the retardation of a direction perpendicular to the Rth of the biaxial film.

18. The liquid crystal display of claim 14, wherein the biaxial film has a slow axis and a fast axis, and the phase difference is generated between light of the slow axis direction and light of a direction of the fast axis by λ/4 wavelength.

19. The liquid crystal display of claim 18, wherein the transmittance axes of the first and second polarizers, and the fast axis or the slow axis of the biaxial film, make angles in the range of about 25 degrees to about 65 degrees, or about −25 degrees to about −65 degrees.

20. The liquid crystal display of claim 19, wherein the transmittance axes of the first and second polarizers, and the fast axis or slow axis of the biaxial film, make angles of about ±45 degrees.

21. The liquid crystal display of claim 14, further comprising:
a liquid crystal layer formed between the first and second substrates,
wherein the liquid crystal layer has a vertical alignment mode.

22. The liquid crystal display of claim 14, further comprising:
alignment layers respectively formed on the inner surfaces of the first and the second substrates.

23. The liquid crystal display of claim 22, wherein the alignment layers are rubbed.

24. The liquid crystal display of claim 14, further comprising:
a plurality of pixel electrodes formed on the first substrate; and
a common electrode formed on the second substrate.

25. The liquid crystal display of claim 24, wherein the pixel electrodes have a plurality of pixel electrode portions and at least one connection for electrically connecting the pixel electrode portions, and the common electrode has a set of cutouts respectively disposed on the center of the pixel electrode portions.

26. The liquid crystal display of claim 25, wherein the pixel electrode portions have a rectangular shape with rounded corners.
